(19) United States
(12) Patent Application Publication
(10) Pub. No.: US 2008/0030158 A1
(43) Pub. Date: Feb. 7, 2008

(54) Centrifugal Fan

(75) Inventors: Naotaka Shibuya, Kyoto (JP); Masayuki Kato, Kyoto (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NIDEC CORPORATION, Kyoto (JP)

(21) Appl. No.: 11/462,379

(22) Filed: Aug. 4, 2006

(51) Int. Cl. H02P 7/00

(52) U.S. Cl. 318/434

(57) ABSTRACT

In a centrifugal fan including an impeller, a motor for rotating the impeller and housing, the electric power is limited such that the power consumption of the centrifugal fan when it is employed in a device is equivalent to the rated electric power of the device for enhancing the static pressure and the air quantity during usage.

### BACKGROUND OF THE INVENTION

1. Technical Field

The present invention relates to a centrifugal fan, a motor for rotating an impeller of the fan, a driving-circuit unit by which the motor is driven and a centrifugal fan designing method and more particularly to improvement of the air flow characteristics of a centrifugal fan employing a constant-voltage power supply.

2. Description of the Related Art

Electrical and electronic equipment (hereinafter, referred to simply as “devices”) such as consumer electronics and appliances employ a fan for cooling, blowing and exhausting. Centrifugal fans have excellent characteristics on the static pressure, which is the pressure generated by the fan.

There is a correlation between the air quantity and the static pressure of a fan and such a relationship is referred to as a P-Q characteristic. Further, when a fan is actually incorporated into a device, there is an air flow resistance within the device and such an air flow resistance is referred to as a system impedance.

FIG. 1 illustrates the P-Q characteristic diagram of a conventional centrifugal fan. The x axis represents the air quantity Q [m³/min] and the left-side y axis represents the static pressure P [Pa]. A centrifugal fan exhibits a characteristic that the static pressure decreases with increasing air quantity, as represented by a characteristic line 11. As indicated by a solid line 12 which represents the system impedance, in order to increase the air quantity passing through the device, the static pressure must be increased.

The intersection point of the curve indicating the system impedance and the curve indicating the P-Q characteristic of the centrifugal fan is referred to as a working point 13 and indicates the static pressure and the air quantity of the centrifugal fan when it is incorporated in the device. The system impedance is automatically determined by the device into which the centrifugal fan is incorporated. In order to enhance the static pressure and air quantity characteristics at the working point, it is necessary to raise the curve 11 indicating the P-Q characteristic upwardly in the graph.

A centrifugal fan includes an impeller having plural blades, a motor for rotating the impeller and a housing which supports the motor and defines an airflow path. In many cases, direct-current motors are employed as the motors of centrifugal fans. The motor for the fan is provided with a direct-current power supply and the voltage thereof is maintained constant. FIG. 1 illustrates the relationship between the electric current and the air quantity of the centrifugal fan which is supplied with electricity from such a power supply. The right-side y axis in FIG. 1 represents the power consumption [W]. A curve 14 indicating the power consumption represents the tendency of the power consumption to be increased with increasing air quantity and to be greatest when the air quantity is greatest. The power consumption is the product of the voltage and the electric current and, in the case of using a constant-voltage power supply, an increase in the power consumption means an increase in the electric current value.

In general, a given power supply has a rated power consumption, i.e., the maximum permissible electric power value, for its motor. The fan is designed such that its power consumption does not exceed the rated power. In the case of FIG. 1, the rated power is 12 [w]. At the working point 13 at which the fan is actually used, the motor is operated at power consumption which is always lower than the rated power by a difference 16. This means that there is a margin, or waste, of electric power relative to the rated power.

By designing the motor of the fan such that the power consumption at the working point becomes the rated power, maximum performance of the fan can be achieved. However, it is likely that the air quantity could exceed that of the working point under some conditions, which would cause the power consumption to exceed the rated power.

### BRIEF SUMMARY OF THE INVENTION

A centrifugal fan of the present invention is driven by a motor, a power supply of which includes or is equipped with an electric power limiting circuit for limiting the power consumption of the motor. The circuit limits the current not to exceed a current corresponding to the rated power. The motor used for the fan is more powerful than that of conventional ones so as to consume power equal or nearly equal to the rated power at the working point. Even if the air quantity exceeds that at working point by some cause, the consumed power never exceeds the rated power because of the current limiting circuit.

By utilizing the present invention, it is possible to enhance the air quantity and the static pressure at the working point of a centrifugal fan without causing the power consumption of the motor of the centrifugal fan to exceed the rated power. Further, by designing the motor of the centrifugal fan such that the power consumption thereof is equivalent to the rated power when the static pressure is highest, it is possible to improve the static pressure of the centrifugal fan over any air quantity ranges.

When the fan of the present invention is incorporated into a device into which a conventional fan has been incorporated, it is possible to offer an enhanced static pressure and an enhanced air quantity than conventional. Further, even when the rated power of the device is reduced, it is possible to offer performance equivalent to or higher than conventional.

In the present invention, the motor driving circuit may include, as the electric power limiting circuit, a circuit which detects the increase in the electric current and reduces the voltage to maintain the power consumption constant.

In the present invention, the motor may be fed with a pulse-shaped electric current at a constant frequency and the aforementioned electric power limiting circuit may vary the duty factor which is a ratio between the electric-current ON time and the electric-current OFF time. This is a so-called pulse width modulation (PWM) driving method. If the electric power exceeds the limit, the limiting circuit decreases the duty factor and reduces the consumed power.

In the present invention, the electric power limiting circuit comprises at least one resistor for detecting the magnitude of the electric current by measuring the potential difference between both end thereof. The electric current is limited through watching the measured magnitude.

Further, in the present invention, the motor driving circuit may include, as the electric-power limiting circuit, a device which is connected in series to the coils of the motor and varies its internal resistance depending on the electric current or variants which vary therewith so that the voltage applied to the coil is controlled to limit the power consumption of the motor.

Further, in the present invention, the motor driving circuit may include, as the electric-power limiting circuit, a rotation-speed detecting circuit for detecting the rotation speed and an electric-current controlling circuit for feeding an electric current in accordance with the rotation speed.

Further, in the present invention, the motor driving circuit may include, as the electric-power limiting circuit, a detector for detecting said rotation speed, the electric current or the electric potential difference between the opposite ends of a resistor connected in series to the coil of the motor, an A/D converter for converting the detected analog values into digital values and a comparison operating portion for comparing the digital signals with a predetermined value to determine whether or not the electric current is to be limited.

The present invention can enhance the air quantity and the static pressure of a centrifugal fan which is employed in a device having a predetermined rated power.

Other features, elements, steps, advantages and characteristics of the present invention will become more apparent from the following detailed description of preferred embodiments thereof with reference to the attached drawings.

### BRIEF DESCRIPTION OF THE SEVERAL VIEWS OF THE DRAWINGS

FIG. 1 is a graph illustrating examples of the P-Q characteristic of a conventional centrifugal fan and the relationship between the motor power consumption and the air quantity of the centrifugal fan;

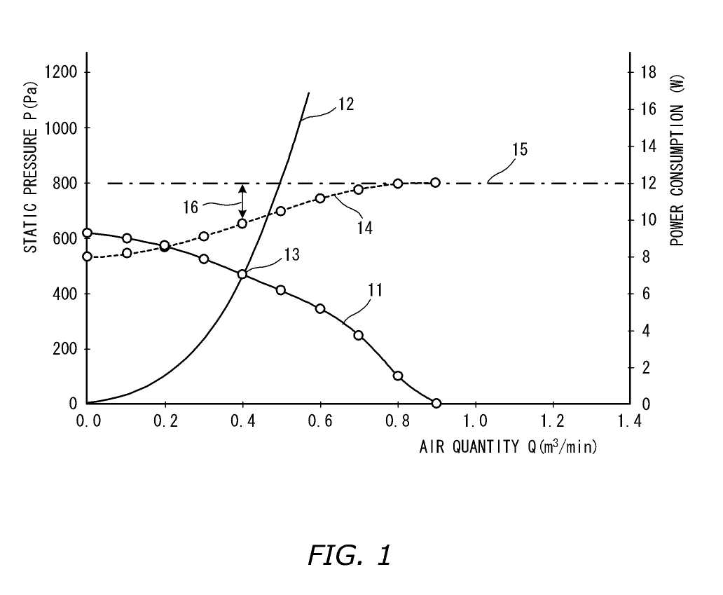

FIG. 2 is a graph illustrating the relationship between the P-Q characteristic and the power consumption of a centrifugal fan according to the present invention at a first stage and the relationship between the motor power consumption and the air quantity of the centrifugal fan;

FIG. 3 is a graph illustrating the relationship between the P-Q characteristic and the power consumption of a centrifugal fan according to the present invention at a second stage and the relationship between the motor power consumption and the air quantity of the centrifugal fan;

FIG. 4 is a graph illustrating the relationship between the P-Q characteristic and the power consumption of the centrifugal fan according to the present invention and the conventional centrifugal fan and the relationship between the motor power consumption and the air quantity of the centrifugal fans;

FIG. 5 is a circuit diagram illustrating the driving circuit of a centrifugal fan according to a first embodiment of the present invention;

FIG. 6 is a circuit diagram illustrating the portion of the electric-current limiting circuit, out of the driving circuit of a centrifugal fan according to a first embodiment of the present invention;

FIG. 7 is a diagram illustrating the electric current waveform when an electric-current limit is imposed on the centrifugal fan according to the first embodiment of the present invention;

FIG. 8 is a block diagram illustrating the driving circuit for a centrifugal fan according to a second embodiment of the present invention;

FIG. 9 is a process flow chart illustrating a program of a microprocessor 42 of the centrifugal fan according to the second embodiment of the present invention;

FIG. 10 is a circuit diagram illustrating an electric-current limiting circuit for a centrifugal fan according to a third embodiment of the present invention;

FIG. 11 is a circuit diagram illustrating an electric-current limiting circuit for a centrifugal fan according to a forth embodiment of the present invention;

FIG. 12 is a circuit diagram illustrating an electric-current limiting circuit for a centrifugal fan according to a sixth embodiment of the present invention; and

FIG. 13 is an oblique view illustrating the electronic equipment having a centrifugal fan according to the present invention.

### DETAILED DESCRIPTION OF THE INVENTION

Embodiments of the present invention will be described using the drawings. In the description of the embodiments of the present invention, the terms designating directions and positions will designate directions and positions in the drawings, unless otherwise specified.

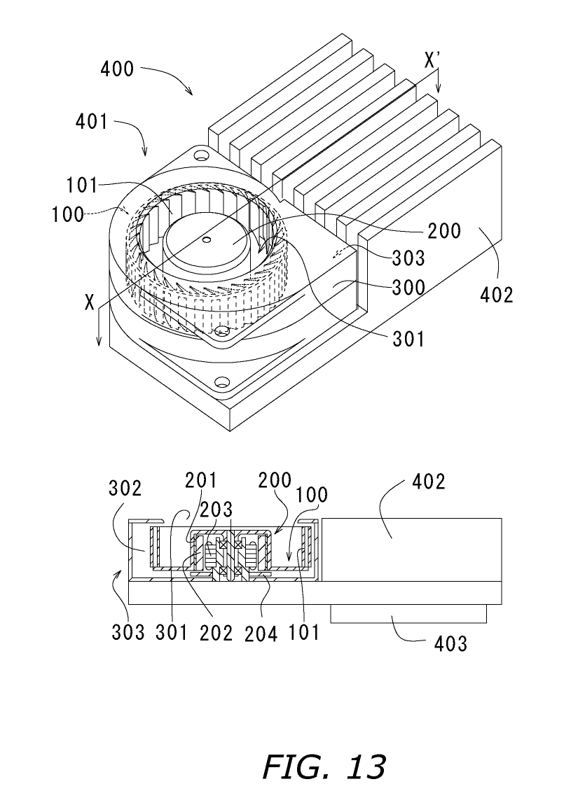

First, the structure and the operation of an electronic device and a centrifugal fan attached thereto will be described. FIG. 13 illustrates an exemplary structure of an electronic device 400 and a centrifugal fan 401 according to the present invention. The centrifugal fan includes an impeller 100 having blades 101, a motor 200 for rotating the impeller 100, and a housing 300 which supports the motor 200, houses the impeller 100 and forms an air flow path. The motor 200 includes a rotor holder 201 on which the impeller 100 is mounted, a rotor magnet 202 mounted to the rotor holder, a stator 203 including plural coils which is provided at a position radially opposite to the rotor magnet 202 in a non-contact manner and a driving circuit 204 for controlling the energization of the coils. The housing 300 includes an inlet opening 301 formed above the centrifugal fan for blowing air into the housing, a flow path 302 having a radial width increasing gradually along the direction of rotation of the impeller 100 which is formed radially outside of the impeller 100, and an outlet opening for discharging air radially outwardly in the circumferential direction which is formed in the side surface (outer peripheral surface) that is continuous with the flow path.

When the impeller 100 is rotated by the motor 200, air is radially outwardly guided from the radial inside of the blades 101 through the centrifugal force. This decreases the air pressure radially inside of the impeller 100 while increasing the air pressure radially outside thereof. The inlet opening 301 of the housing 300 is opened at the radially inner portion, thus blowing air thereinto from outside of the housing. On the other hand, the outlet opening 303 of the housing is opened radially outside of the impeller 100, thus discharging air outside from the inside of the housing. Through the aforementioned phenomenon, air is guided from the inlet opening to the outlet opening.

A heat sink 402 is placed in the flow path made by the centrifugal fan 401. The heat sink radiates heat which is generated by the electronic part 403 attached to the bottom face of the heat sink. The heat sink can efficiently radiate heat when the centrifugal fan blows the air to the heat sink. The heat sink can be placed near the inlet opening of the fan when the air flow toward the inlet opening cools the heat sink.

A centrifugal fan according to present invention can be adopted for uses other than cooling. Supplying air into a box or chassis is an example.

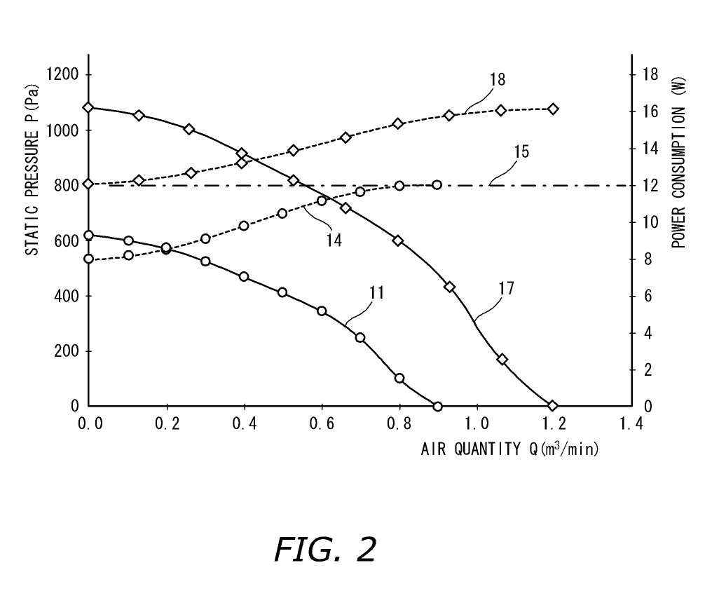

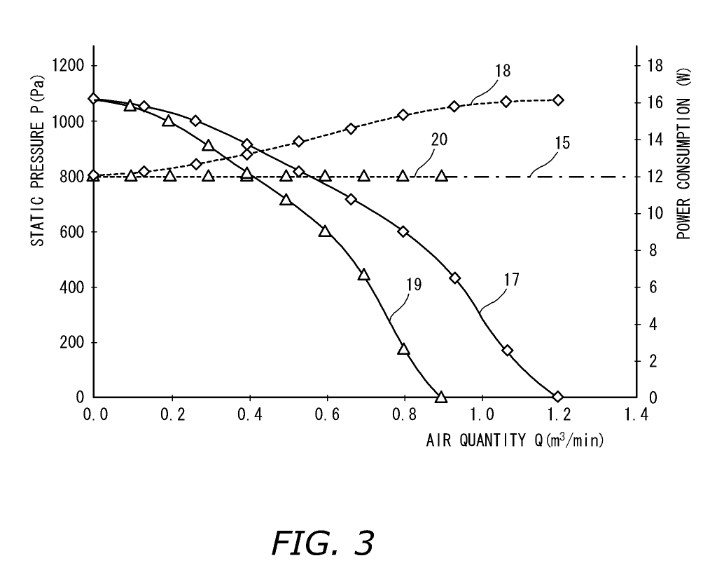

FIG. 2 to FIG. 4 illustrate the relationship between the static pressure and the air quantity (hereinafter, referred to as a P-Q characteristic) and the relationship between the power consumption and the air quantity (hereinafter, referred to as an electric power characteristic) of the centrifugal fan according to the present invention. In the graphs, the horizontal axis designates the air quantity Q [m³/min] of the centrifugal fan and the vertical axis designates the static pressure P [Pa] and the power consumption W [w]. In a centrifugal fan, the air quantity tends to decrease with increasing static pressure. When the static pressure is highest, the centrifugal fan does not blow air and therefore the air quantity is 0. Further, when the static pressure is 0, the air quantity becomes largest since the blown air is not hindered.

In a conventional centrifugal fan, the static pressure is highest when the outlet opening is closed to stop air. In this condition, the work of the motor is the minimum. On the other hand, when the air quantity is largest, the work of the motor becomes largest. Consequently, the power consumption increases with increasing air quantity. Numerical 14 in FIG. 2 denotes a curve of the electric power characteristic of such conventional motor while numerical 11 denotes a curve of P-Q characteristic of the motor.

A dashed line 15 designates an example of the rated power for the motor which the centrifugal fan is equipped with. In the graphs, the rated power is, for example, 12 [w] and, in the case of employing a power supply with a constant voltage of 12 [v], the motor is permitted electric current of up to 1 [A].

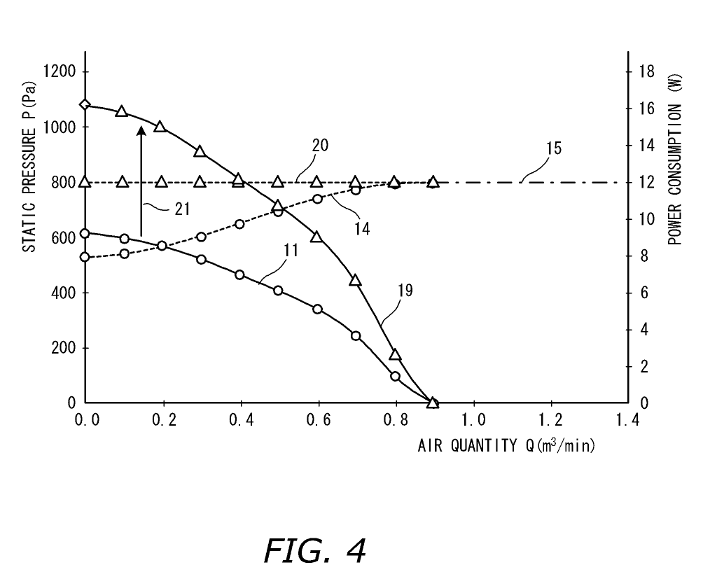

In the present invention, a more powerful motor is provided for the centrifugal fan. Such a motor can rotate at higher speed with the same voltage supply and consumes more current and power. The capacity of the motor is selected so that it consumes the rated power when the fan is driven under the condition in which the air quantity is zero. Numeral 17 denotes a curve indicating the P-Q characteristic and numeral 18 denotes a curve indicating the electric power characteristic if an electric-current limiting-circuit does not exit. This motor consumes electric power greater than the rated power when the air quantity is larger than 0. With the electric-current limiting-circuit, the curve for the electric power characteristic is shifted to be a dashed horizontal line denoted by numerical 20, while a curve of the P-Q characteristic is changed to be a curve denoted by numerical 19. Although the curve 19 is shifted downward compared to curve 17, the curve is shifted upward dramatically from the curve 11, which is indicated by the arrow 21 in FIG. 4.

While the rated power 15 is equivalent to that of the conventional fan, the static pressure is significantly increased for the same air quantities. Further, at the working point indicating the performance of the fan when it is incorporated in the device, the static pressure and the air quantity on the P-Q characteristic of the fan are both largely increased. Further, with the present invention, the power limit is imposed on the circuit and, therefore, it is possible to prevent the power consumption from exceeding the rated power of the device, for example, due to an increase of the load of the motor.

The electric current and the voltage are controlled such that the product of the voltage and the electric current is maintained constant by the electric-current limiting circuit. In the case of using a constant-voltage power supply as the power supply, an electric current limit may be imposed thereon such that the electric current does not exceed a constant value. Also, when the electric current varies, the voltage may be varied in accordance therewith.

Further, the power limit according to the present invention is made effective by setting the motor power consumption to be equal to the rated power at least at the working point. Namely, it is not necessary that the power consumption of the motor becomes equal to the rated power of the device when the static pressure is highest.

Further, in the present invention, when a conventional centrifugal fan satisfies the P-Q characteristic required for the device, it is possible to impose the power limit at an electric power equivalent to the power consumption of the conventional centrifugal fan at the working point. This can reduce the rated power of the device, thereby saving the power consumption of the entire device.

Hereinafter, concrete embodiments of the power limit according to the present invention will be described.

### First Embodiment

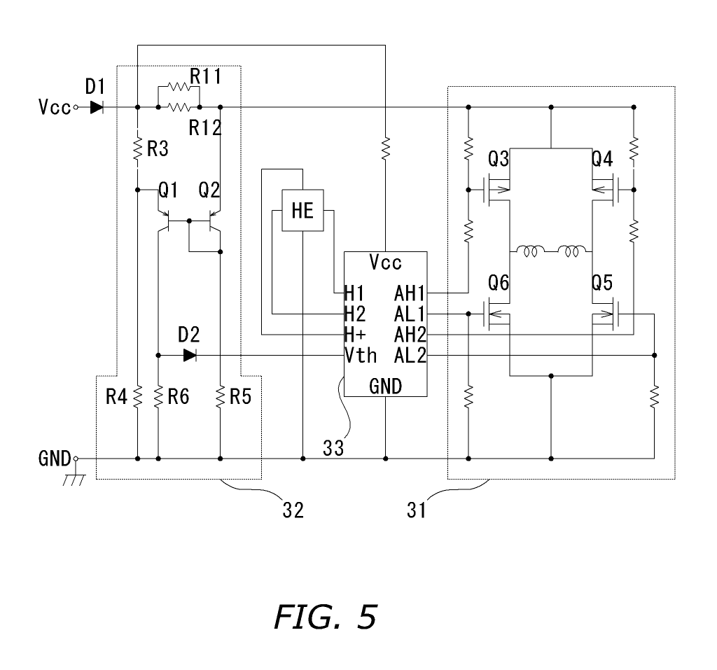

FIG. 5 is a view illustrating main components of a motor driving circuit which realizes the present invention. This circuit is fed with electric power from a constant-voltage power supply. This circuit includes a power unit 31, an electric-current detecting portion 32 and a motor drive IC 33 capable of performing PWM driving. As a single-phase full-wave fan motor driver capable of performing PWM driving, it is possible to employ BD6718FS manufactured by Rohm Corporation or LB11967V manufactured by Sanyo Electric Corporation.

The drive IC includes terminals “H1” and “H2” for inputting signals from a Hall device which is a rotational position sensor, a PWM oscillation circuit (oscillator), and four terminals “AH1”, “AH2”, “AL1” and “AL2” connected to the gates of power transistors constituting the power unit 31 for controlling the ON/OFF of the power transistors. In the present embodiment, when the AH1 is brought into an effective high level and the AL1 is brought into an effective low level, the power transistors Q3 and Q6 are turned on, thus causing a rightward electric current to flow. When the AH2 is brought into an effective high level and the AL2 is brought into an effective low level, the power transistors Q4 and Q5 are turned on, thus causing a leftward electric current to flow. The timing of level switching can be determined by comparing the electric potentials of the terminal voltages H1 and H2 of the Hall device. This motor driving method is referred to as single-phase full-wave driving.

Under the condition where the power transistors Q3 and Q5 (or Q4 and Q6) are ON, the effective value of the electric current flowing through the stator is controlled by PWM control. The PWM control method controls the pulse width of a pulse-waveform electric current with a sufficiently shorter period (for example, 25 kHz) than the rotation period to change the ratio of the time period during which the current is ON and the time period during which the current is OFF for controlling the electric current effective value. The ratio between the ON time period and the OFF time period is referred to as the duty factor. In particular, by controlling the duty factor, it is possible to control the effective value of the electric current flowing through the motor, thus controlling the power consumption of the motor. The motor drive IC capable of performing PWM driving according to the present embodiment includes a terminal “Vth” for controlling the duty factor of the PWM. Further, this control can be realized by inputting a predetermined electric potential and input signals to one of the terminals of a comparison amplifier while inputting a waveform such as a triangular waveform generated by the oscillation circuit to the other terminal to perform a comparison operation.

According to the present embodiment, the output signal from the electric current detecting circuit 32 is input to the terminal Vth for controlling the duty factor. The electric current detecting circuit 32 detects the electric current being supplied to the power unit 31 from the power supply voltage VCC and generates an output signal according to the electric current. With the aforementioned circuit structures, the effective value of the electric current is controlled such that it does not exceed a predetermined value. By using the aforementioned circuit structures, it is possible to limit the power consumption of the motor to the rated power of the device.

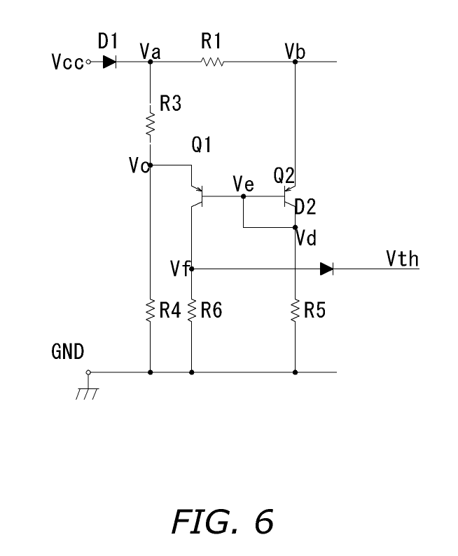

The operation of the electric-current detecting circuit 32 will be described in detail, with reference to FIGS. 5 and 6. FIG. 6 illustrates the electric-current detecting circuit 32 in the circuit of FIG. 5 in a partially simplified manner. In FIG. 5, two resistors R11 and R12 which are connected in parallel with each other are inserted in the electric-current path from the power-supply voltage VCC to the power unit 31 and, in FIG. 6, these resistors R11 and R12 are designated as a single resistor R1. Namely, the following equation holds: R1=R11×R12/(R11+R12).

In FIG. 6, assuming that an electric current I is supplied from the power-supply voltage VCC to the power unit 31 through the resistor R1, a voltage drop of R1×I is generated between the opposite ends of the resistor R1. In this case, Va equals VCC−0.7 V (assuming that the forward current through D1 in FIG. 5 is 0.7 V) and Vb equals to VCC−R1×I. Although the electric current I contains the electric current supplied to the motor drive IC 33, this electric current is negligibly small in comparison with the electric current supplied to the power unit 31. When the electric current I supplied to the power unit 31 is increased to increase the voltage drop R1×I between the opposite ends of the resistor R1, the output voltage of the electric current detecting circuit 32 (the input voltage to the motor drive IC 33) Vth is increased in a manner which will be described later. As a result, the motor drive IC 33 controls the ON/OFF control signals supplied to the gates of the power transistors Q3 and Q6 (or Q4 and Q5) to reduce the duty factor thereof.

In the electric-current detecting circuit 32 of FIG. 6, assuming that the voltage between the emitter and the base of Q2 is Vtr, when Q2 is turned on, Ve becomes Vb−Vtr. Further, assuming that the voltage between the emitter and the base of Q1 is Vtr similarly to that of Q2, Vc is equal to Ve+Vtr, which is equal to Va−R1×I. Namely, there is formed a mirror current circuit realizing Vb=Vc, wherein the electric current I2 flowing through R3 satisfies the following equation; I2=(Va−Vc)/R3=(R1/R3)I. Consequently, Vf is equal to (R1/R3)I×R6 and Vth is equal to Vf, and therefore Vth is determined by I, R6, R1 and R3. As described above, when the electric current I flowing through R1 is increased, Vth is increased.

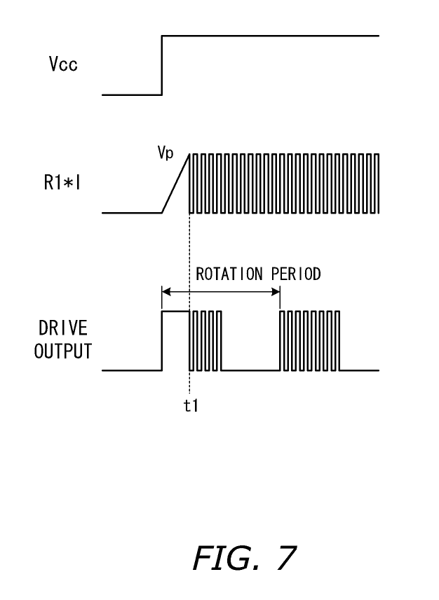

FIG. 7 is a waveform diagram illustrating the operation of the electric-current limit during the activation of the centrifugal fan according to the present embodiment. The electric current I is gradually increased starting at the rising edge of VCC and, consequently, the voltage drop R1×I across the resistor R1 is gradually increased. The voltage drop R1×I exceeds a predetermined value of Vp at a time t1, and then the duty factor of the signals supplied to the gates of the power transistors Q3 and Q6 (or Q4 and Q5) from the motor drive IC 33 is decreased, thus increasing the time period during which the electric current is OFF.

As described above, when the electric current I supplied to the power unit 31 is increased, the output voltage Vth of the electric-current detecting circuit 32 is increased and thus the motor drive IC 33 controls the ON/OFF control signals supplied to the gates of the power transistors Q3 and Q6 (or Q4 and Q5) to reduce the duty factor thereof in accordance with the increase of the output voltage Vth. Consequently, the electric current I supplied to the power unit 31 is controlled to be a constant value through the feedback loop. As a result, the power consumption of the power unit 31 is prevented from exceeding the rated power.

### Second Embodiment

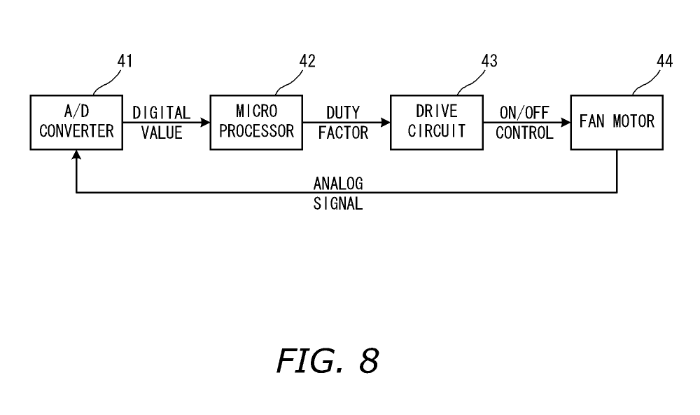

FIG. 8 is a block diagram illustrating the structure of an electric-current limiting circuit of a centrifugal fan according to a second embodiment of the present invention. The centrifugal fan according to the present embodiment executes PWM control similarly to that in the first embodiment through software processing by a microprocessor. Therefore, the electric-current limiting circuit according to the present embodiment includes an A/D converter 41, a microprocessor 42, and a driving circuit 43 as illustrated in FIG. 8. Analog signals (voltage signals) corresponding to the electric current being supplied to a fan motor 44 are fed back to the A/D converter 41. The A/D converter 41 converts the input analog signals corresponding to the electric current into digital values, and outputs them to the microprocessor 42.

The microprocessor 42 compares the input digital values corresponding to the electric current with a predetermined reference value and determines the duty factor for the PWM control in accordance with the result of the comparison. The microprocessor 42 provides signals indicative of the determined duty factor to the driving circuit 43, and the driving circuit 43 performs ON/OFF control of the fan motor 44 in accordance with the signals.

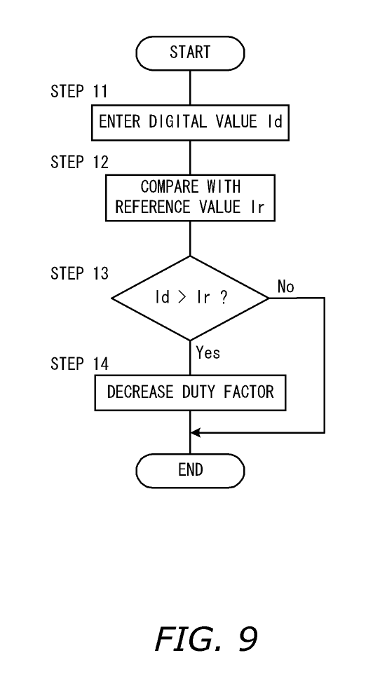

FIG. 9 is a flow chart illustrating an example of the process which is executed by the microprocessor 42 in accordance with a pre-stored program. At Step 11, a digital value Id corresponding to the electric current is input and, at Step 12, the digital value Id is compared with a predetermined reference value Ir. When the digital value Id is greater than the reference value Ir (Yes is resulted from Step 13), the duty factor is reduced by a certain amount at Step 14. When the digital value Id is equal to or smaller than the reference value Ir, Step 14 is skipped. Also, the digital value Id may be compared with the predetermined reference value Ir to calculate the difference therebetween, and the duty factor may be controlled by varying the amount of reduction thereof at Step 14.

Through the aforementioned process, the microprocessor 42 executes the feedback control for reducing the duty factor in accordance with the increase of the electric current supplied to the fan motor 44. Consequently, similarly to in the first embodiment, the electric current supplied to the fan motor 44 is limited to prevent the power consumption of the fan motor 44 from exceeding the rated power.

### Third Embodiment

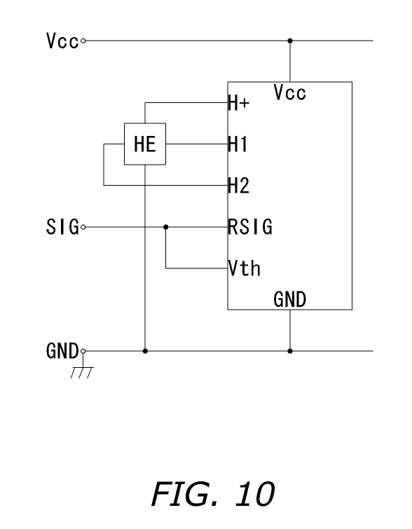

FIG. 10 is a circuit diagram illustrating an electric-current limiting circuit of a centrifugal fan according to a fourth embodiment of the present invention. This circuit is constituted by an IC which outputs a rotation-speed signal RSIG in accordance with the outputs H1 and H2 of a rotational position detector such as a Hall device HE. The rotation speed signal RSIG is set such that the electric potential thereof is increased with increasing rotation speed. When the signal is input to the PWM control terminal Vth of the motor drive IC according to the first embodiment, the duty factor is controlled to be reduced with increasing rotation speed. There is a constant ratio between the rotation speed and the electric current value, which enables controlling the duty factor for limiting the electric current by detecting a certain rotation speed being reached.

As a modified embodiment of the present embodiment, the rotation speed may be converted into a digital value and a program may cause a microprocessor to execute an operation for comparing the digital value with a predetermine rotation speed and reducing the duty factor for limiting the electric current, as in the second embodiment.

### Fourth Embodiment

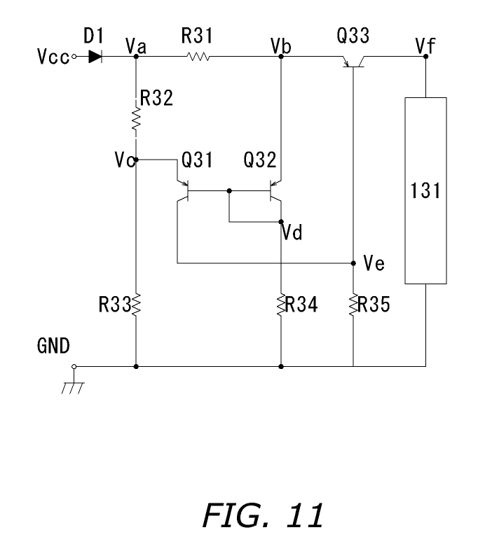

FIG. 11 is a circuit diagram illustrating an electric-current limiting circuit of a centrifugal fan according to a fourth embodiment of the present invention. This circuit operates as follows. First, there are the following relationships between the voltages Va to Ve at respective points in the circuit diagram and the electric current I flowing through R31; Va=Vcc, Vb=Va−R31*I, Vc=Va−R31*I, Vd=Va−R31*I−0.7V, and Ve=Vc. Further, assuming that electric currents of i2 and i3 flow through R35 and R33, respectively, the following relationships hold; Ve=R35*i2 and Vc=R33*i3

Consequently, there are the following relationships: i2=(Va−R31×I)/R51; and i3=(Va−R11)/R3. Due to these relationships, when the electric current I is increased, the voltage between the source and the gate of Q33 is reduced and the resistance between the source and the drain is increased, thus reducing the voltage Vf applied to the power unit 131 of the fan motor, and reducing the power consumption of the fan motor. Namely, Q33 works as a variable resistor. As a result, the power consumption of the fan motor is controlled such that it does not exceed the rated power.

### Fifth Embodiment

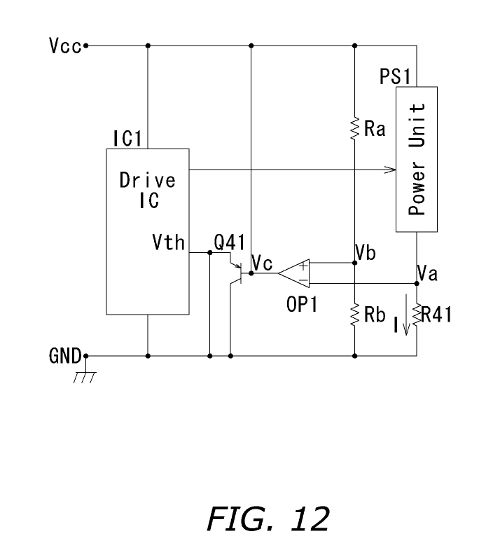

FIG. 12 is a circuit diagram illustrating an electric-current limiting circuit of a centrifugal fan according to a fifth embodiment of the present invention. In this circuit according to the present embodiment, a resistor R41 connected in series to the stator coil L1 of the fan motor serves as an electric-current detecting resistor and, assuming that an electric current of I is flowing through the stator coil L1, Va is equal to R41×I This voltage is input to the non-inverting input terminal of an operation amplifier OP while a reference voltage Vb is input to the inverting input terminal thereof. Here, Vb is equal to Rb×Vcc/(Ra+Rb). The differential amplification output voltage Vc resulted from the reference voltage Vb and the detection voltage Va, which is proportional to the electric current I, is applied to the base of a transistor Q41. The collector output thereof is input to a motor-driving integrated circuit IC1 as the PWM-controlling input voltage Vth. Through the PWM-controlling output from the integrated circuit IC1, the power unit PS1 is driven and, consequently, the effective value of the electric current supplied to the stator coil L1 is controlled. As described above, with the present embodiment, similarly, the power consumption of the fan motor is controlled such that it does not exceed the rated power.

While the present invention has been described with reference to some embodiments hereinbefore, the present invention is not limited to these embodiments and may be implemented in various aspects. As another embodiment, for example, a thermistor (temperature-dependent variable resistor) may be employed instead of an electric-current detecting resistor to determine the power consumption of the fan motor on the basis of the temperature rise therein, and may control the power consumption such that it does not exceed the rated power. Also, a semiconductor device (a diode or transistor) which varies its resistance depending on the electric current therethrough may be connected in series to the motor so that the electric potential of the motor is reduced to maintain the power consumption of the motor constant. Also, an LED (light-emitting diode) may be employed to convert the electric current into a light intensity and then the light may be detected by a photodiode.

Also, it is possible to detect a physical quantity such as the rotation speed of the fan motor which has a known correlation with the electric current value, and control the electric current supplied to the fan motor on the basis of the physical quantity. Instead of controlling the electric current supplied to the fan motor, it is possible to control the power supply voltage to prevent the power consumption from exceeding the rated power. This control can be easily performed by utilizing a microcomputer capable of converting signals into digital values and making a comparison between numerical values.

While the present invention has been described with respect to preferred embodiments, it will be apparent to those skilled in the art that the disclosed invention may be modified in numerous ways and may assume many embodiments other than those specifically set out and described above. Accordingly, it is intended by the appended claims to cover all modifications of the present invention which fall within the true spirit and scope of the invention.

What is claimed is:

1. A centrifugal fan comprising:
an impeller;
a housing having an air inlet and an air outlet, the housing for accommodating the impeller therein;
a motor for rotating the impeller relative to the housing;
a motor driving circuit for driving the motor at a predetermined magnitude of dc voltage; and
an electric-power limiting circuit for controlling the motor driving circuit to limiting the power consumption of the motor to its rated power consumption, the rated power consumption being set to be smaller than the electric power consumed by the motor when the limiting circuit is not present or not in operation, and both the inlet and the outlet are free of any external objects that hamper fan airflow.

2. A centrifugal fan as set forth in claim 1, wherein said maximum permissible electric power is set to the electric power consumed by the motor when the limiting circuit is not present or not working and a flow of the air is hampered by an external object placed either near the inlet or near the outlet.

3. A centrifugal fan as set forth in claim 1, wherein said maximum permissible electric power is set to be equal or smaller than the electric power consumed by the motor when the limiting circuit is not present or not working and either the inlet or the outlet is closed by an external object.

4. A centrifugal fan for making an air flow in which a device radiating heat is positioned, the centrifugal fan having a certain position and direction relative to the device when the fan is used, comprising:
an impeller;
a housing having an inlet and an outlet of air, the housing accommodating the impeller therein;
a motor for rotating the impeller relative to the housing;
a motor driving circuit which drives the motor by a predetermined magnitude of DC voltage; and
an electric-power limiting circuit which limits the power consumption of the motor to a maximum permissible electric power by controlling the motor driving circuit, the maximum permissible electric power being set to be smaller than the electric power consumed by the motor when the limiting circuit is not present or not working and the device is not present.

5. A centrifugal fan as set forth in claim 4, wherein said maximum permissible electric power is set to the electric power consumed by the motor when the limiting circuit is not present or not working and a flow of the air is hampered by an external object placed either near the inlet or near the outlet.

6. A centrifugal fan as set forth in claim 4, wherein said maximum permissible electric power is set to be equal or smaller than the electric power consumed by the motor when the limiting circuit is not present or not working and either the inlet or the outlet is closed by an external object.

7. Electronic equipment comprising:
a device radiating heat;
a centrifugal fan having an impeller, a housing accommodating the impeller therein, a motor driving the impeller and a motor driving circuit which drives the motor by a predetermined magnitude of DC voltage, the centrifugal fan being fixed to have certain position and direction relative to the electronic device;
an electric-power limiting circuit which limits the power consumption of the motor to a maximum permissible electric power by controlling the motor driving circuit, the maximum permissible electric power being set to be smaller than the electric power consumed by the motor when the limiting circuit is not present or not working and the electronic device is not present.

8. Electronic equipment as set forth in claim 7, wherein said maximum permissible electric power is set to the electric power consumed by the motor when the limiting circuit is not present or not working and a flow of the air is hampered by the electronic device.

9. Electronic equipment as set forth in claim 7, wherein said maximum permissible electric power is set to be equal or smaller than the electric power consumed by the motor when the limiting circuit is not present or not working and either the inlet or the outlet is closed by an external object.

10. A centrifugal fan as set forth in claim 1, wherein said motor driving circuit and said electric-power limiting circuit are placed on one circuit board.

11. A centrifugal fan as set forth in claim 2, wherein said motor driving circuit and said electric-power limiting circuit are placed on one circuit board.

12. A centrifugal fan as set forth in claim 3, wherein said motor driving circuit and said electric-power limiting circuit are placed on one circuit board.

13. A centrifugal fan as set forth in claim 4, wherein said motor driving circuit and said electric-power limiting circuit are placed on one circuit board.

14. A centrifugal fan as set forth in claim 5, wherein said motor driving circuit and said electric-power limiting circuit are placed on one circuit board.

15. A centrifugal fan as set forth in claim 6, wherein said motor driving circuit and said electric-power limiting circuit are placed on one circuit board.

16. Electronic equipment as set forth in claim 7, wherein said motor driving circuit and said electric-power limiting circuit are placed on one circuit board.

17. Electronic equipment as set forth in claim 8, wherein said motor driving circuit and said electric-power limiting circuit are placed on one circuit board.

18. Electronic equipment as set forth in claim 9, wherein said motor driving circuit and said electric-power limiting circuit are placed on one circuit board.
